(19) United States
(12) Patent Application Publication
(10) Pub. No.: US 2014/0114719 A1
(43) Pub. Date: Apr. 24, 2014

(54) Allocating Service Consumers into Compatible Resource Pools

(71) Applicant: INTERNATIONAL BUSINESS MACHINES CORPORATION, Armonk, NY (US)

(72) Inventors: Dipyaman Banerjee, New Delhi (IN); Gargi B. Dasgupta, Bangalore (IN); Nirmit V. Desai, Bangalore (IN)

(73) Assignee: International Business Machines Corporation, Armonk, NY (US)

(21) Appl. No.: 13/654,564

(22) Filed: Oct. 18, 2012

(51) Int. Cl. G06Q 10/06

(52) U.S. Cl. 705/7.25; 705/7.12

(57) ABSTRACT

Techniques, a system and an article of manufacture for allocating accounts among resource pools. A method includes creating a set of customer account allocations by assigning customer account combinations from a set of customer accounts among a given set of resource pools, computing a compatibility score for each of the customer account allocations by comparing a profile of a resource pool and a profile of each customer account assigned to the resource pool in the customer account allocation based on a workload parameter, a demographics parameter, and/or an effort parameter, simulating execution of a pre-determined number of customer account allocations, wherein the pre-determined number is based on a compatibility score threshold, selecting one of the customer account allocations based on results of the simulated execution, and allocating the set of customer accounts among the set of resource pools in accordance with the selected customer account allocation.

### FIELD OF THE INVENTION

Embodiments of the invention generally relate to information technology, and, more particularly, to shared delivery of services.

### BACKGROUND

As part of implementing a global service delivery framework, customer accounts are often grouped together and serviced by common skill-based resource pools. However, existing account grouping approaches are based largely on guess-work rather than actual performance data. Accordingly, such existing approaches can result in service level agreement (SLA) violations for one or more accounts, over or under utilization of certain resource pools, lost opportunities in attempting to minimize labor costs, etc.

Further, an allocation can soon become out of date due to factors such as a workload from an account changing with time, growth or shrinkage of an account, addition or subtraction of accounts from a resource pool, subtraction of resources due to attrition, skill and expertise of resources changing over time, etc.

Consequently, a need exists for evidence-based techniques that can utilize historical data to model alternate allocations accurately and select an efficient allocation in a cost-effective manner.

### SUMMARY

In one aspect of the present invention, techniques for allocating service consumers into compatible resource pools are provided. An exemplary computer-implemented method for allocating a single account and/or multiple accounts among at least one resource pool can include steps of creating a set of customer account allocations by assigning customer account combinations from a set of customer accounts among a given set of resource pools, computing a compatibility score for each of the customer account allocations by comparing a profile of a resource pool and a profile of each customer account assigned to the resource pool in the customer account allocation based on a workload parameter, a demographics parameter, and/or an effort parameter, simulating execution of a pre-determined number of customer account allocations, wherein the pre-determined number is based on a compatibility score threshold, selecting one of the customer account allocations based on results of the simulated execution, and allocating the set of customer accounts among the set of resource pools in accordance with the selected customer account allocation.

Another aspect of the invention includes steps of adding a new customer account to a set of customer accounts present in multiple resource pools, creating a set of customer account allocations by assigning multiple customer account combinations from the set of customer accounts among the resource pools, computing a compatibility score for each of the customer account allocations by comparing a profile of the resource pool and a profile of each customer account assigned to the resource pool in the customer account allocation based on a workload parameter, a demographics parameter, and/or an effort parameter, simulating execution of a pre-determined number of customer account allocations, wherein the pre-determined number is based on a compatibility score threshold, selecting one of the customer account allocations based on results of the simulated execution, and allocating the set of customer accounts among the resource pools in accordance with the selected customer account allocation.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and operative to perform noted method steps.

Yet further, another aspect of the invention or elements thereof can be implemented in the form of means for carrying out the method steps described herein, or elements thereof; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques for allocating a single account and/or multiple accounts among at least one resource pool, according to an embodiment of the invention; and

FIG. 3 is a system diagram of an exemplary computer system on which at least one embodiment of the invention can be implemented.

### DETAILED DESCRIPTION

As described herein, an aspect of the present invention includes efficiently allocating service consumers to resource pools. At least one embodiment of the invention includes (re)-structuring a service organization by allocating customers (accounts) to service or resource pools, wherein such allocation decreases the overall staffing costs for servicing the customers as well as the differential in resource utilizations across pools. Also, such (re)-structuring aims to maintain the performance against contractual SLA targets for each customer, and maintain the average resource utilizations in pools under a predefined threshold. Further, as described herein, an aspect of the invention includes estimating compatibility among customers allocated to a service pool.

As used herein, a service line includes a set of N accounts A={a₁, a₂, . . . , a_{N}} and M resource pools P={P₁, P₂, . . . , P_{M}}, where each pool Pᵢ services a subset Aᵢ of the accounts, and where

$${{⋂}^{M}}_{i = 1} {A}_{i} = φ and {{⋂}_{i = 1}}^{M} {A}_{i} = A .$$

Workload arrival distributions for each account can include ticket work and non-ticket work. The workload volume can vary with the hour of the day and the day of the week, and accounts can be distributed geographically and operate in different time zones.

The service time distribution for ticket and non-ticket work is based on the complexity, severity and type of the ticket, as well as the expertise and skill level of the resource (which can be categorized as low, medium, or high, for example). Each account can have an SLA target for each ticket severity level that needs to be met. Also, each account aᵢ has time-variant ticket arrival rate λₐ_{ᵢ}(t).

As described herein, an aspect of the invention includes (re)grouping the N accounts into M pools {P₁, P₂, . . . , P_{M}} such that SLAs and corresponding severity for each account are met within a predetermined confidence interval, the sum total of staffing cost across all pools is minimized, utilization of resources in each pool remains under a threshold, and/or the average utilization of the pools is similar (that is, Max(avg pool util)−Min(avg. pool util)<K) across all pools.

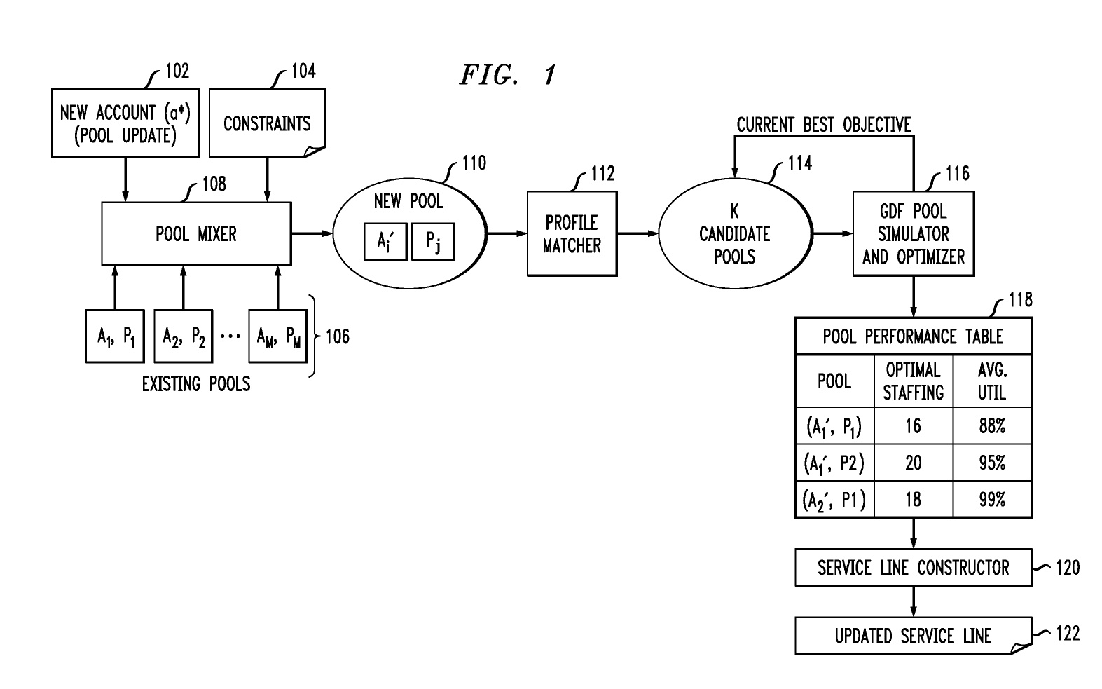

FIG. 1 is a block diagram illustrating an example embodiment, according to an aspect of the invention. By way of illustration, FIG. 1 depicts a pool mixer component 108, which can be used for updating resource pools. Specifically, for a pool update (A′ᵢ∈{a*∪A₁, a*∪A₂, . . . , a*∪A_{M}}), the pool mixer component 108 creates a set of new pools 110 by adding a new account 102 to the group of accounts present in each existing pool 106, and forwards the new pools 110 to a profile matcher component 112. In the above equation, a* represents a new account and A₁, A₂, . . . , AM denotes the existing set of accounts in each pool P₁, P₂, . . . , PM, respectively. Accordingly, the above equation indicates that for a pool update, any new grouping of accounts denoted by Aᵢ* {i=1 to M} (created by the pool mixer) belongs to the set of groups formed by adding the new account a* to the existing set of accounts in each pool. (Note that in FIG. 1, a new pool 110 is denoted as (Aᵢ′, Pⱼ), and for a pool update case, i=j.)

For pool reconfiguration

$$( {A}_{i}^{′} ⊆ A = {{⋃}_{i = 1}}^{M} {A}_{i} ) ,$$

the pool mixer component 108 creates a set of new pools 110 by assigning all possible account subsets from the entire set of accounts across the service line to the existing resource pools 106 and forwards the new pools 110 to the profile matcher component 112. The latter part of the equation

$$( A = {{⋃}_{i = 1}}^{M} {A}_{i} )$$

denotes that A is the set of all accounts across all pools. The beginning part of the equation states that for pool reconfiguration, any new grouping of accounts denoted by Aᵢ′ {i=1 to 2^{|A|}−1} (created by the pool mixer) is a non-null subset of A (for instance, there are 2^{|A|}−1). A list of constraints 104 is used to filter out combinations of accounts where accounts cannot be grouped together due to management and/or security issues.

The profile matcher component 112 computes a compatibility score for each of the resource pools created by the pool mixer component 108 by comparing the pool profiles and account profiles in the following dimensions: workload, demographics, and effort. Additionally, the profile matcher component 112 outputs the top K candidate pools 114 based on the compatibility score for a simulation-based evaluation to be carried out, for example, by a global delivery framework (GDF) pool simulator and optimizer component 116.

As also depicted in FIG. 1, a pool performance table 118 holds the optimal staffing and corresponding average utilization values for each candidate pool as obtained from the simulation carried out by component 116. The pool performance table 118 is used to determine the most desirable and/or advantageous pool allocation across the service line. Accordingly, a service line constructor component 120 selects a group of pools from the pool performance table 118 such that all of the accounts in the service line are covered, staffing cost is minimized across the service line and resource utilization constraints are satisfied. The service line constructor component 120 can thus select the most advantageous combination of pools based on the simulation results to form an updated service line 122. Further, at least one embodiment of the invention can include using a search engine to generate a ranked ordering of recommendations for (account, pool) groupings.

Accordingly, as illustrated via FIG. 1, at least one embodiment of the invention includes intelligently using a single-pool simulator to model various alternate allocations of accounts over multiple pools in a service line (that is, a what-if analysis) and determining the most efficient allocation among those various allocations (that is, an optimization). The framework as depicted in FIG. 1 additionally implements a compatibility estimation based pruning mechanism to prune the exponential search space of all possible account-pool combinations and restricts the number of pools that need to be simulated. Also, at least one embodiment of the invention can include using a dynamic programming technique (by retaining the previous pool simulation results) to expedite individual pool optimizations.

In connection with the function(s) of the profile matcher component 112 depicted in FIG. 1, a workload profile of a pool represents how the workload comes in or arrives during certain hours of a day, and/or day of the week. A workload profile can be derived from the individual workload patterns of accounts. Additionally, the workload profile of a pool Pⱼ and an account aᵢ are compatible if, after the inclusion of a, in Pⱼ, the risk of a SLA violation in the pool does not increase. However, because adding more workload cannot guarantee a non-increase of risk, at least one embodiment of the invention considers an account aᵢ as optimally workload compatible to a pool Pⱼ if, after the inclusion of aᵢ in Pⱼ, the risk of a SLA violation in the pool is minimal. By way of example, consolidating non-correlated workloads raises minimal risk of SLA violations.

At least one embodiment of the invention can include representing a pool's workload as a time series Tsᵢ{x₁, x₂, . . . x_{N}}, and representing a new account's workload as a time series Taᵢ={y₁, y₂, . . . y_{N}}. Accordingly, the co-relation coefficient computed across a time series can be one indicator of workload compatibility.

For example, for the above two time series, the sample person co-efficient r_{xy} is given as:

$${r}_{xy} = \frac{n \sum {x}_{i} {y}_{i} - \sum {x}_{i} \sum {y}_{i}}{\sqrt{n \sum {x}_{i}^{2} - {( \sum {x}_{i} )}^{2}} \sqrt{n \sum {y}_{i}^{2} - {( \sum {y}_{i} )}^{2}}} .$$

The demographic profile of a pool represents how shifts are arranged in terms of human skills and timing, as well as what the existing SLA attainments are. Demographic profiles of a pool and an account can be matched, for example, on the following heuristics:

Serving accounts in time zones similar to existing accounts in a pool reduces the need to change shift timing;

Accounts with similar SLAs, when grouped together, lead to more efficient dispatching; and

When the complexity distribution of tickets in a new account workload follows the existing skill present in a pool, the match is more appropriate or effective.

The effort profile of a pool represents how much time it currently takes the pool to perform work. The effort profiles of a pool and an account are compatible if the time taken to perform the new account's work adds a minimal amount of time to the existing staff's work hours (for example, per day). In an example embodiment of the invention, the average hours per day per staff member can be computed before and after a new account's inclusion in various resource pools, and the pool wherein the difference is the smallest is identified as the best match with respect to effort profile.

Additionally, at least one embodiment of the invention includes implementing a refinement such that the differential in resource utilizations across pools is minimized, and/or the average resource utilization in pools is maintained under a predefined threshold.

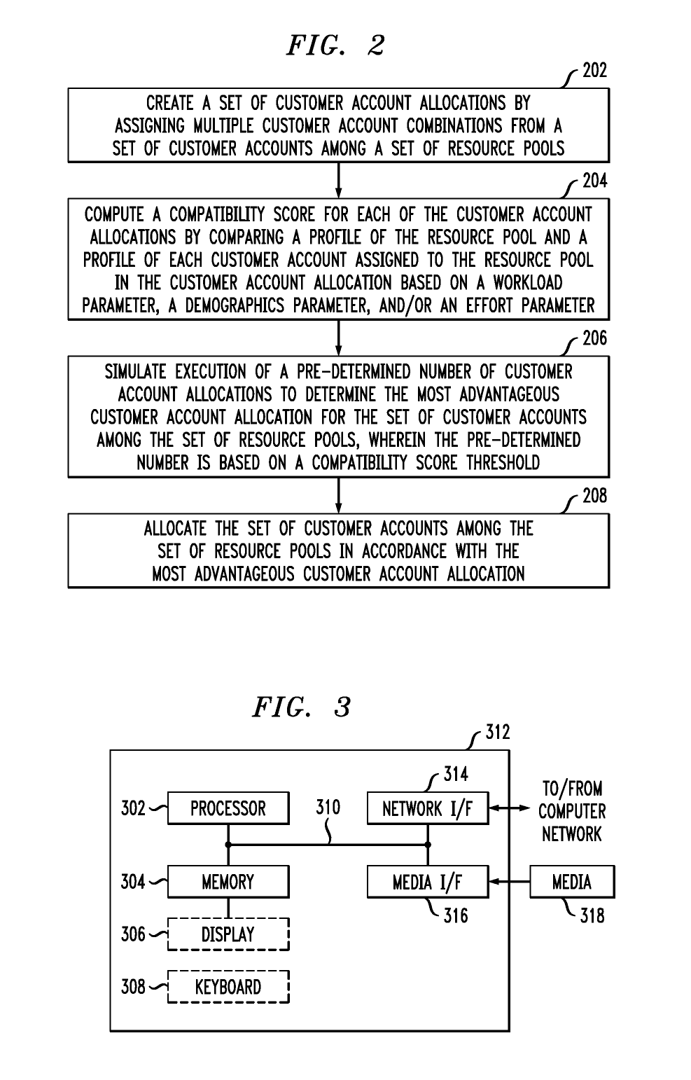

FIG. 2 is a flow diagram illustrating techniques for allocating a single account and/or multiple accounts among at least one resource pool, according to an embodiment of the present invention. Step 202 includes creating a set of customer account allocations by assigning multiple customer account combinations from a set of customer accounts among a given set of resource pools. At least one embodiment of the invention can also include creating a set of customer account allocations by adding a new customer account to a set of customer accounts present in each of multiple existing resource pools.

Step 204 includes computing a compatibility score for each of the customer account allocations by comparing a profile of the resource pool and a profile of each customer account assigned to the resource pool in the customer account allocation based on a workload parameter, a demographics parameter, and/or an effort parameter.

Step 206 includes simulating execution of a pre-determined number of customer account allocations to determine the most advantageous customer account allocation for the set of customer accounts among the set of resource pools, wherein the pre-determined number is based on a compatibility score threshold. Determining the most advantageous customer account allocation can include minimizing a staffing cost for servicing the set of customer accounts, minimizing a differential in resource utilizations across the set of resource pools, maintaining a pre-determined performance level against service level agreement (SLA) targets for each customer account, and/or maintaining an average resource utilization in the set of resource pools under a predefined threshold.

The compatibility score threshold can be based on a predetermined workload parameter value, a predetermined demographics parameter value, and/or a predetermined effort parameter value. Additionally, at least one embodiment of the invention can also include using a list of constraints to filter out customer account combinations where two or more accounts cannot be grouped together due to a management and/or a security issue. Also, at least one embodiment of the invention includes sorting the pre-determined number of customer account allocations in descending order by the number of accounts in each customer account allocation.

Further, step 208 includes allocating the set of customer accounts among the set of resource pools in accordance with the most advantageous customer account allocation.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in a computer readable medium having computer readable program code embodied thereon.

An aspect of the invention or elements thereof can be implemented in the form of an apparatus including a memory and at least one processor that is coupled to the memory and operative to perform exemplary method steps.

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer).

The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Accordingly, an aspect of the invention includes an article of manufacture tangibly embodying computer readable instructions which, when implemented, cause a computer to carry out a plurality of method steps as described herein.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, structuring a service organization by allocating customer accounts to resource pools in an efficient manner.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for allocating a single account and/or multiple accounts among at least one resource pool, the method comprising:
creating a set of customer account allocations by assigning multiple customer account combinations from a set of customer accounts among a given set of resource pools;
computing a compatibility score for each of the customer account allocations by comparing a profile of a resource pool and a profile of each customer account assigned to the resource pool in the customer account allocation based on a workload parameter, a demographics parameter, and/or an effort parameter;
simulating execution of a pre-determined number of customer account allocations, wherein the pre-determined number is based on a compatibility score threshold;
selecting one of the customer account allocations based on results of the simulated execution; and
allocating the set of customer accounts among the set of resource pools in accordance with the selected customer account allocation;
wherein at least one of the steps is carried out by a computer device.

2. The method of claim 1, comprising:
using a list of constraints to filter out a customer account combination wherein two or more accounts cannot be grouped together due to a management and/or a security issue.

3. The method of claim 1, wherein said selecting comprises determining a customer account allocation that minimizes a staffing cost for servicing the set of customer accounts.

4. The method of claim 1, wherein said selecting comprises determining a customer account allocation that minimizes a differential in resource utilizations across the set of resource pools.

5. The method of claim 1, wherein said selecting comprises determining a customer account allocation that maintains a pre-determined performance level against one or more service level agreement (SLA) targets for each customer account.

6. The method of claim 1, wherein said selecting comprises determining a customer account allocation that maintains an average resource utilization in the set of resource pools under a predefined threshold.

7. The method of claim 1, wherein the compatibility score threshold is based on a predetermined workload parameter value.

8. The method of claim 1, wherein the compatibility score threshold is based on a predetermined demographics parameter value.

9. The method of claim 1, wherein the compatibility score threshold is based on a predetermined effort parameter value.

10. The method of claim 1, comprising:
sorting the pre-determined number of customer account allocations in descending order by the number of accounts in each customer account allocation.

11. An article of manufacture comprising a computer readable storage medium having computer readable instructions tangibly embodied thereon which, when implemented, cause a computer to carry out a plurality of method steps comprising:
creating a set of customer account allocations by assigning multiple customer account combinations from a set of customer accounts among a given set of resource pools;
computing a compatibility score for each of the customer account allocations by comparing a profile of a resource pool and a profile of each customer account assigned to the resource pool in the customer account allocation based on a workload parameter, a demographics parameter, and/or an effort parameter;
simulating execution of a pre-determined number of customer account allocations, wherein the pre-determined number is based on a compatibility score threshold;
selecting one of the customer account allocations based on results of the simulated execution; and
allocating the set of customer accounts among the set of resource pools in accordance with the selected customer account allocation.

12. The article of manufacture of claim 11, wherein said selecting comprises determining a customer account allocation that minimizes a staffing cost for servicing the set of customer accounts.

13. The article of manufacture of claim 11, wherein said selecting comprises determining a customer account allocation that minimizes a differential in resource utilizations across the set of resource pools.

14. The article of manufacture of claim 11, wherein said selecting comprises determining a customer account allocation that maintains a pre-determined performance level against one or more service level agreement (SLA) targets for each customer account.

15. The article of manufacture of claim 11, wherein said selecting comprises determining a customer account allocation that maintains an average resource utilization in the set of resource pools under a predefined threshold.

16. The article of manufacture of claim 11, wherein the compatibility score threshold is based on a predetermined workload parameter value.

17. The article of manufacture of claim 11, wherein the compatibility score threshold is based on a predetermined demographics parameter value.

18. The article of manufacture of claim 11, wherein the compatibility score threshold is based on a predetermined effort parameter value.

19. A system for allocating a single account and/or multiple accounts among at least one resource pool, comprising:
at least one distinct software module, each distinct software module being embodied on a tangible computer-readable medium;
a memory; and
at least one processor coupled to the memory and operative for:
creating a set of customer account allocations by assigning multiple customer account combinations from a set of customer accounts among a given set of resource pools;
computing a compatibility score for each of the customer account allocations by comparing a profile of a resource pool and a profile of each customer account assigned to the resource pool in the customer account allocation based on a workload parameter, a demographics parameter, and/or an effort parameter;
simulating execution of a pre-determined number of customer account allocations, wherein the pre-determined number is based on a compatibility score threshold;
selecting one of the customer account allocations based on results of the simulated execution; and
allocating the set of customer accounts among the set of resource pools in accordance with the selected customer account allocation.

20. A method for allocating a single account and/or multiple accounts among at least one resource pool, the method comprising:
adding a new customer account to a set of customer accounts present in multiple resource pools;
creating a set of customer account allocations by assigning multiple customer account combinations from the set of customer accounts among the resource pools;
computing a compatibility score for each of the customer account allocations by comparing a profile of the resource pool and a profile of each customer account assigned to the resource pool in the customer account allocation based on a workload parameter, a demographics parameter, and/or an effort parameter;
simulating execution of a pre-determined number of customer account allocations, wherein the pre-determined number is based on a compatibility score threshold;
selecting one of the customer account allocations based on results of the simulated execution; and
allocating the set of customer accounts among the resource pools in accordance with the selected customer account allocation;
wherein at least one of the steps is carried out by a computer device.
